(19) United States
(12) Patent Application Publication
(10) Pub. No.: US 2024/0200628 A1
(43) Pub. Date: Jun. 20, 2024

(54) FRICTION MATERIAL COMPOSITION AND FRICTION MATERIAL

(71) Applicant: ADVICS CO., LTD., Kariya-shi, Aichi-ken (CN)

(72) Inventors: Junichi UJITA, Kariya-shi, Aichi-ken (JP); Hiroki HASEGAWA, Kariya-shi, Aichi-ken (JP)

(73) Assignee: ADVICS CO., LTD., Kariya-shi, Aichi-ken (JP)

(21) Appl. No.: 18/556,010

(22) PCT Filed: May 25, 2022
(86) PCT No.: PCT/JP2022/021436

§ 371 Date: Oct. 18, 2023

(30) Foreign Application Priority Data
May 25, 2021 (JP) 2021-087907

(51) Int. Cl. F16D 69/02

(52) U.S. Cl. CPC F16D 69/028; F16D 2200/0021; F16D 2200/0043; F16D 2200/0069; F16D 2200/0086

(57) ABSTRACT

A friction material composition including a fiber substrate, a binder, an organic filler and an inorganic filler, wherein the content of copper in the friction material composition is 5% by mass or less in terms of elemental copper, and the friction material composition includes magnesite as the inorganic filler.

### TECHNICAL FIELD

The present disclosure relates to a friction material composition and a friction material.

### BACKGROUND ART

In a disk brake pad and a brake shoe of a braking device such as a disk brake or a drum brake, a friction material is used.

PTL 1 discloses a friction material composition having a composition where copper as the element is not included in the friction material composition or the content of copper is 0.5% by mass or less based on the whole friction material composition, and containing particles having a melting point of 2000° C. or more, a Vickers' hardness of 500 to 1500 and an average particle size of 15 to 50 μm as the inorganic filler in an amount of 1 to 50% by mass and a titanate in an amount of 5 to 30% by mass. It is disclosed therein that the friction material obtained by molding the friction material composition is capable of not only retaining a high friction coefficient at the time of high-speed and high-load braking but also exhibiting an excellent wear resistance.

PTL 2 discloses a friction material composition having a composition where copper as the element is not included in the friction material composition or the content of copper is 0.5% by mass or less based on the whole friction material composition, and containing one or two or more of the inorganic filler selected from γ-alumina, dolomite, calcium carbonate, magnesium carbonate, manganese dioxide, zinc oxide, magnetite, cerium oxide, and zirconia, each having a specific average particle size. It is disclosed therein that the friction material obtained by molding the friction material composition is excellent in fade resistance and wear resistance at a high temperature of more than 500° C.

### CITATION LIST

### Patent Literature

PTL 1: JP2017-2230A
PTL 2: WO2016/060129

### SUMMARY

### Technical Problem

However, with respect to the conventional friction materials such as those described above, wear resistance in a high temperature range such as the temperature at the time of high-speed high-load braking is excellent, but wear is caused in a large amount in an ordinary temperature range such as the temperature at the time of street driving, thereby resulting in a short lifetime of the friction material, and therefore, there is some room to be improved.

An embodiment of the present disclosure has an object of providing a friction material not only being excellent in effect and wear resistance at the time of high-speed braking in a high temperature range but also exhibiting sufficient wear resistance in an ordinary temperature range.

### Solution to Problem

The present inventors have conducted an intensive research to solve the above problems and first have found that the friction material, which contains magnesite as an inorganic filler in a composition having a copper content of 5% by mass or less in terms of elemental copper is excellent in effect and wear resistance at the time of high-speed braking in a high temperature range and simultaneously exhibits sufficient wear resistance in an ordinary temperature range, thereby achieving the disclosed result. Namely, a friction material composition according to an embodiment of the present disclosure is a friction material composition including a fiber substrate, a binder, an organic filler and an inorganic filler, and having a constitution where the content of copper in the friction material composition is 5% by mass or less in terms of elemental copper, and the friction material composition includes magnesite as the inorganic filler.

### Advantageous Effects

According to an embodiment of the present disclosure, based on a composition having a content of copper, which has a high environment burden, of 5% by mass or less in terms of elemental copper, a friction material which is excellent in effect and wear resistance at the time of high-speed braking in a high temperature range and simultaneously exhibits sufficient wear resistance in an ordinary temperature range can be provided.

### DESCRIPTION OF EMBODIMENTS

### <1. Friction Material Composition>

The friction material composition according to an embodiment of the present disclosure is a friction material composition including a fiber substrate, a binder, an organic filler and an inorganic filler,
wherein the content of copper in the friction material composition is 5% by mass or less in terms of elemental copper, and the friction material composition includes magnesite as the inorganic filler. The friction material composition according to the embodiment is intended to be one obtained by compounding the above-described raw materials (friction material raw materials). The friction material composition according to the embodiment can be used for the friction material described later.

### Characteristics

The friction material composition according to the embodiment exhibits the following effects: since the content of copper in the friction material composition is 5% by mass or less in terms of elemental copper, the environment burden is less, and since magnesite is included as the inorganic filler, a friction material which is excellent in effect and wear resistance at the time of high-speed braking in a high temperature range and simultaneously exhibits sufficient wear resistance in an ordinary temperature range, as compared with the conventional friction materials, can be provided.

The friction material obtained by using the friction material composition according to the embodiment is satisfactory in both wear resistance at the time of high-speed braking in a high temperature range (for example, 600° C. or more) and wear resistance in an ordinary temperature range (for example, 200° C. or less), and therefore exhibits an effect of having a long lifetime as compared with the conventional friction materials. The friction material obtained by using the friction material composition according to the embodiment is excellent in wear resistance, and therefore, the amount of the dust generated by wear is less. As a result thereof, the friction material exhibits the effects that wheels are less subject to becoming dirty with the dust, and the discharged amount of PM 2.5 which exhibits a high environmental burden is less.

### Application

The friction material composition according to the embodiment having the characteristics described above is particularly useful as the friction material composition which is used for a friction material to be used for the friction surface of a disk brake pad or a brake shoe for a drum brake for an electric vehicle (EV) or a hybrid electric vehicle (HEV). This is because the EV/HEV have a heavy vehicle weight, as compared with the conventional gasoline-powered vehicles, due to a large-sized battery mounted thereon, the contribution of regenerative brake at the time of high-speed braking tends to be low, the temperature of the brake pad or the brake shoe at the time of high-speed braking in the high temperature range is apt to be increased, and the frequency of reaching high temperature is increased.

The application of the friction material composition according to the embodiment is not limited to the EV/HEV, and the friction material composition according to the embodiment can be preferably used for the friction surface of a disk brake pad, a brake shoe for a drum brake, or the like, which is adopted for the whole vehicles including two-wheeled vehicles.

### (Raw Materials)

In the following, the raw materials included in the friction material composition according to the embodiment (friction material raw materials) are described below.

### (Copper)

With respect to the friction material composition according to the embodiment of the present disclosure, the content of copper in the friction material composition is 5% by mass or less in terms of elemental copper. With respect to the friction material composition according to the embodiment of the present disclosure, the content of copper and a copper alloy, which are high in environmental hazards, is small, and the friction material composition according to the embodiment exhibits the effect that a friction material being environmentally friendly can be provided. From the viewpoint of providing the friction material being more environmentally friendly, the content of copper in the friction material composition is preferably 0.5% by mass or less in terms of elemental copper, more preferably 0% by mass (free of copper).

Copper included in the friction material composition according to the embodiment of the present disclosure may be derived from a copper fiber added as the fiber substrate. In this case, from the viewpoint of restraining wear in an ordinary temperature range, it is preferred that the content of the copper fiber in the friction material composition is 5% by mass or less.

### (Magnesite)

The friction material composition according to the embodiment of the present disclosure contains magnesite as the inorganic filler. Magnesite is also referred to as anhydrous magnesium carbonate. Magnesite includes a magnesium component in an amount of 46% by mass or more in terms of MgO. On the other hand, the general magnesium carbonate produced industrially is a basic magnesium carbonate (nMgCO₃·MgOH₂·mH₂O, where m=3 to 5, and n=3 to 7), and the amount of the magnesium component is 40% by mass or more and 44% by mass or less in terms of MgO. This definitely distinguishes magnesite from the general magnesium carbonate.

### (Action and Effect of Magnesite)

The magnesium component included in magnesite is capable of forming a smooth coating film on the friction surface through friction, since the hardness and the yield stress become low with an increased temperature at the time of high-speed braking in a high temperature range. The coating film not only increases the contact area of the friction surface to enhance the friction coefficient (u) but also protects the friction surface to enhance the wear resistance.

Since magnesite does not include a hydrated water unlike the basic magnesium carbonate, desorption of a hydrate is not caused with increase of the temperature. Therefore, the friction material including magnesite is less prone to be subjected to change in volume attributable to desorption of a hydrate and decrease in strength which is attributable to decomposition of the resin included in the friction material composition by a hydrate. As a result thereof, crack of the friction material, which is attributable to the strength lowered at the time of high-speed braking in the high temperature range, is less prone to cause, and wear resistance in an ordinary temperature range is also satisfactory.

### (Content of Magnesite)

The content of magnesite in the friction material composition is not limited particularly, and can be appropriately determined as long as the effects anticipated when magnesite is incorporated are sufficiently exhibited. From the viewpoint of enhancing the performance (effect and wear resistance) of the friction material at the time of high-speed braking in the high temperature range, the content of magnesite in the friction material composition is preferably 1% by mass or more, preferably 5% by mass or more, more preferably 10% by mass or more, per 100% by mass of the friction material composition. Further, from the viewpoint of enhancing the lifetime performance of the friction material in an ordinary temperature range, the content of magnesite in the friction material composition is preferably 15% by mass or less, preferably 10% by mass or less, more preferably 6% by mass or less, per 100% by mass of the friction material composition. It is preferred that the content of magnesite in the friction material composition is 1% by mass or more and 10% by mass or less per 100% by mass of the friction material composition, since the lifetime performance at time of high-speed braking in the high temperature range and the lifetime performance in an ordinary temperature range both are satisfactory in a good balance, and the compounding balance with the other components contained in the friction material composition is good.

### (Preferred Particle Size of Magnesite)

The particle size of martensite is not limited particularly, and it is preferred that the average particle size of martensite is 50 μm or less, since it is possible to prepare a uniform mixture without unevenness in producing the friction material composition, and particles of magnesite are less prone to desorb from the friction surface at the time of braking, whereby the effect of enhancing the performance (effect and wear resistance) of the friction material at the time of high-speeding braking in the high temperature range can be stably exhibited. Further, from the viewpoint of the handling property at producing the friction material composition, it is preferred that the average particle size of magnesite is 1 μm or more. Here, the average particle size of magnesite is the median size, in terms of volume, according to JIS Z 8825 “Particle size analysis—Laser diffraction methods”. For confirming the particle size of magnesite after the formation of the friction material, with regard to the average particle size of particles corresponding to magnesite in an electron microscope image of the cross section of the friction material, the particle size distribution in terms of volume are measured according to JIS Z 8827-1: “Particle size analysis-Image analysis methods-Part 1: Static image analysis method”, and the median size can be then determined.

### (Fiber Substrate)

As the fiber substrate, examples thereof include an organic fiber, an inorganic fiber, a metal fiber, and the like. Such a fiber may be a natural fiber or a synthetic fiber synthesized artificially. Examples of the organic fiber include an aromatic polyamide fiber (aramid fiber), an acrylic fiber, a cellulose fiber, and a carbon fiber. Examples of the inorganic fiber include a rock wool, and a glass fiber. Examples of the metal fiber include a fiber composed of the sole metal of steel, stainless steel, aluminum, zinc, or tin or a fiber composed of the alloy metal with respect to each of these metals. With respect to the fiber substrate, one kind thereof may be used singly or plural kinds thereof may be used in combination.

The content of the fiber substrate in the friction material composition is not limited particularly, and in the case where the fiber substrate includes a metal fiber, from the viewpoint of restraining the friction material from wearing in an ordinary temperature range, the content of the metal fiber in the friction material composition is preferably 5% by mass or less. Further, from the viewpoint of enhancing the lowest friction coefficient in the high temperature range, it is preferred to include a chromium-containing metal fiber in an amount of 1% by mass or more as the metal fiber. Examples of the chromium-containing metal fiber include a stainless steel fiber (SUS fiber, the content of chromium: 10.5% by mass or more), and a chromium steel (the content of chromium: about 1% by mass). The content of chromium in the chromium-containing metal fiber is not limited particularly, and the chromium-containing metal fiber having a chromium content of 18 by mass or more and 30% by mass or less can be preferably used, and is preferably a stainless steel fiber.

### (Binder)

The binder has the function of binding the friction material raw materials in the friction material composition. The binder is not limited particularly as long as it exhibits the above-described performance, and the binders known in the technical field can be preferably used. Examples of the binder include resins such as a phenol resin, an epoxy resin, a melamine resin, and an imide resin. With respect to the binder, one kind thereof may be used singly or plural kinds thereof may be used in combination. The content of the binder in the friction material composition is not limited particularly, and can be set to the content being ordinarily adopted in the technical field.

### (Organic Filler)

The organic filler functions as a friction-adjusting material for enhancing the wear resistance and the like. The organic filler is not limited particularly as long as it can exhibit the above-described performance. The organic fillers known in the technical field can be preferably used. Examples of the organic filler include cashew dust, rubber powder, tire powder, a fluorine resin, melamine cyanurate, and a polyethylene rein. With respect to the organic filler, one kind thereof may be used singly or plural kinds thereof may be used in combination. The organic filler may be an organic filler, the surface of which is coated with phosphoric acid or a fluorine resin. The content of the organic filler in the friction material composition is not limited particularly, and can be set to the content being ordinarily adopted in the technical field.

(Inorganic Filler other than Magnesite)

The friction material composition according to the embodiment may include an inorganic filler other than magnesite as long as the effect of the present disclosure is not impaired. As the inorganic filler other than magnesite, inorganic substances known in the technical field can be preferably used. Examples thereof include zirconium oxide, barium sulfate, mica, an iron oxide (ferrous oxide, ferric oxide, etc.), a titanate, and calcium hydroxide. Examples of the titanate include an alkali metal titanate and an alkali metal·group 2 salt of titanic acid. Examples thereof includes potassium titanate, sodium titanate, lithium titanate, lithium potassium titanate, and magnesium potassium titanate. With respect to the inorganic filler, one kind thereof may be used singly or plural kinds thereof may be used in combination. The content of the inorganic filler is not limited particularly, and can be set to the content being ordinarily adopted in the technical field. Further, the particle size of the inorganic filler is not limited particularly, and the inorganic substance having the average particle size being ordinarily adopted in the technical field can be preferably used.

### (Lubricant)

Further, the friction material composition according to the embodiment may include a lubricant as long as the effects of the present disclosure are not impaired. The lubricant is not limited particularly, and lubricants known in the technical field can be preferably used. Examples of the lubricant include coke, black lead, carbon black, graphite, and metal sulfide. Examples of metal sulfide include tin sulfide, antimony trisulfide, molybdenum disulfide, bismuth sulfide, iron sulfide, zinc sulfide, and tungsten sulfide. With respect to the lubricant, one kind thereof may be used singly or plural kinds thereof may be used in combination. The content of the lubricant is not limited particularly, and can be set to the content being ordinarily adopted in the technical field.

### (Production Method of Friction Material Composition)

The friction material composition according to the embodiment can be produced by a production method which includes a mixing step including compounding the above-described friction material raw materials, and mixing them. From the viewpoint of mixing uniformly, the mixing step is preferably a step of mixing powder-like friction material raw materials. The mixing method and the mixing conditions for the mixing step are not limited particularly as long as the friction material raw materials can be mixed uniformly, and methods known in the technical field can be adopted. For example, the friction material raw materials can be mixed for about 10 minutes at ordinary temperature using a known mixer such as a HENSCHEL mixer or a LÖDIGE mixer. In the mixing step, the mixing may be performed while the mixture of the friction material raw materials is cooled according to a known cooling method such that the temperature of the friction material raw materials during mixing is not increased.

### <2. Friction Material>

The friction material according to the embodiment of the present disclosure is one obtained by molding the above-described friction material composition according to the embodiment of the present disclosure. The effects and application of the friction material of the embodiment are as described in the description on the friction material composition of the present disclosure, and therefore, no repetition is described here.

### (Production Method of Friction Material)

The friction material according to the embodiment can be produced according to a production method which includes a molding step of molding the friction material composition according to the embodiment of the present disclosure. The molding method and the molding conditions in the molding step are not limited particularly as long as the friction material composition of the present disclosure can be molded into a predetermined shape, and methods known in the technical field can be adopted. For example, the friction material composition of the present disclosure can be molded by pressing and compacting it with a press etc. As the molding method with a press, a hot press method in which molding is performed by pressing and compacting the friction material composition of the present disclosure while heating, and an ordinary-temperature press method in which molding is performed by pressing and compacting the friction material composition of the present disclosure at an ordinary temperature without heating, each can be preferably adopted. In the case of molding by the hot press method, the friction material composition of the present disclosure can be molded into the friction material, for example, by setting the molding temperature to 140° C. or more and 200° C. or less (preferably 160° C.), the molding pressure to 10 Mpa or more and 40 Mpa or less (preferably 20 MPa), and the molding time to 3 minutes or more and 15 minutes or less (preferably 10 minutes). In the case of molding by the ordinary-temperature press method, the friction material composition of the present disclosure can be molded into the friction material, for example, by setting the molding pressure to 50 Mpa or more and 200 Mpa or less (preferably 100 MPa), and the molding time to 5 seconds or more and 60 seconds or less (preferably 15 seconds).

Further, a polishing step of polishing the surface of the friction material to form the friction surface may be performed, if necessary.

### <3. Friction Member>

A friction member having the friction material according to the embodiment of the present disclosure as a friction surface falls within the scope of the present. As the friction member, a constitution where only the friction material of the present is provided, or a constitution where a plate-like member such as a metal plate as a back plate and the friction material of the present are integrated may be adopted. The effects and application of the friction member of the embodiment are as described in the description on the friction material composition according to the present, and therefore, no repetition is described here.

In the case where the friction member has a constitution where a plate-like member and the friction material of the present disclosure are integrated, the friction material of the present disclosure and the plate-like member are subjected to a clamp processing, and then a heat treatment, thereby enabling the adhesion between the friction material of the present disclosure and the plate-like member. The conditions for the clamp processing are not limited particularly, and are, for example, for example, 180° C., 1 MPa, and for 10 minutes. Further, the conditions for the heat treatment after the clamp processing are not limited particularly, and are, for example, 150° C. or more, 250° C. or less, 5 minutes or more, 180 minutes or less, preferably 230° C. for 3 hours.

### Summary

The friction material composition according to Embodiment 1 of the present disclosure is a friction material composition including a fiber substrate, a binder, an organic filler and an inorganic filler, wherein the content of copper in the friction material composition is 5% by mass or less in terms of elemental copper, and the friction material composition includes magnesite as the inorganic filler. Such a constitution exhibits the effects of providing a friction material which is environmentally friendly, is excellent in the effect and the wear resistance at the time of high-speed braking in a high-temperature range, and has a sufficient wear resistance in an ordinary temperature range as compared with the conventional friction material.

The friction material composition according to Embodiment 2 of the present disclosure is a preferred embodiment where, in Embodiment 1, the content of magnesite in the friction material composition is 1% by mass or more and 10% by mass or less. According to such a constitution, the lifetime performance at the time of high-speed braking in the high temperature range and the lifetime performance in an ordinary temperature range both are satisfactory in a good balance, and the compounding balance with the other components included in the friction material composition is good.

The friction material composition according to Embodiment 3 of the present disclosure is a preferred embodiment where, in Embodiment 1 or 2, the average particle size of magnesite is 50 μm or less. According to such a constitution, it is possible to prepare a uniform mixture without unevenness in producing the friction material composition and particles of magnesite are not prone to desorb from the friction surface at the time of braking, whereby the effect of enhancing the performance (effect and wear resistance) of the friction material at the time of high-speeding braking in the high temperature range can be stably exhibited.

The friction material composition according to Embodiment 4 of the present disclosure is a preferred embodiment where, in any one of Embodiments 1 to 3, the content of copper in the friction material composition is 0.5% by mass or less in terms of elemental copper. According to such a constitution, a friction material environmentally friendly can be provided, since the content of copper which is a high environmental burden is small.

The friction material composition according to Embodiment 5 of the present disclosure is a preferred embodiment where, in any one of the Embodiments 1 to 4, the friction material composition includes a chromium-containing metal fiber as the fiber substrate, and the content of the chromium-containing metal fiber in the friction material composition is 1% by mass or more and 5% by mass or less. According to such a constitution, the lowest friction coefficient in the high temperature range can be further enhanced.

The friction material according to Embodiment 6 of the present disclosure is a constitution, obtained by molding the friction material composition of any one of Embodiments 1 to 5.

The present disclosure is not limited to the respective embodiments described above, various modifications can be performed within the scopes described in the claims, and embodiments constituted by appropriately combining the respective technical means disclosed in the different embodiments also fall within the technical scope of the present disclosure.

### EXAMPLES

### <Raw Materials for Friction Material>

The raw materials friction material used in Examples and Comparative Examples are as follows.
Stainless steel fiber: chrome content of 10.5% by mass
Magnesite (anhydrous magnesium carbonate): average particle size 1 μm, 8 μm, 20 μm, or 50 μm
Basic magnesium carbonate: average particle size 10 μm
Dolomite: average particle size 8 μm
Magnesium oxide: average particle size 2 μm
With respect to the raw materials other than the above-described friction raw materials, those being used ordinarily in the technical field were used.

### Example 1

### <Preparation of Brake Pad>

The respective raw materials were compounded according to the compounding rate as indicated in Table 1, and mixed for about 10 minutes at ordinary temperature (20° C.) in a LÖDIGE mixer, thereby obtaining a friction material composition. Incidentally, the unit of the compounded amount of each raw material in Table 1 is % by mass in the friction material composition.

Each molded article was obtained by pressing and compacting the friction material composition during heating by means of a molding press according to a hot press construction method. The molding conditions in the hot press construction method were as follows.
Molding temperature: 160° C.
Molding pressure: 20 MPa
Molding time: 10 minutes

The surface of the obtained molded article was polished with a polisher to form a friction surface, thereby obtaining a friction material. A brake pad of Example 1 was prepared by using the friction material, and then subjected to a high temperature test and a travelling (driving) simulation test. The thickness and the projected area of the friction material of the brake pad prepared in Example 1 were 12.5 mm and 55 cm², respectively.

### Examples 2 to 13

Brake pads of Examples 2 to 13 each was prepared in the same manner as in Example 1 except that the respective raw materials were compounded according to the compounding rate indicated in Table 1.

### Comparative Examples 1 to 12

Brake pads of Comparative Examples 1 to 12 each was prepared in the same manner as in Example 1 except that the respective raw materials were compounded according to the compounding rate indicated in Table 2.

### <High Temperature Test>

The brake pads of Examples 1 to 13 and Comparative Examples 1 to 12 were subjected to an AMS fade test (Evaluation condition described in German automobile magazine “auto motor und sport”: car speed of 130 km/hour, maximum rotor temperature of 600° C. or more), and the following evaluation was performed.

### (Lowest Friction Coefficient)

The lowest friction coefficient at the AMS fade test was measured according to the following method.

### (Method of Measuring Lowest Friction Coefficient)

The friction coefficient of each braking was calculated using the lowest torque during one braking according to the calculation formula described in JIS D 0106. During the test, friction coefficient which was lowest was designated as “lowest friction coefficient”.

The results of measurement of the lowest friction coefficient were evaluated in terms of five steps 1 to 5 according to the following criteria
5: improved more than 20% as compared with Comparative Example 1
4: improved 10% or more and 20% or less as compared with Comparative Example 1
3: the same as or comparable to Comparative Example 1
2: deteriorated 10% or more and 20% or less as compared with Comparative Example 1
1: deteriorated more than 20% as compared with Comparative Example 1

Here, the case where the lowest friction coefficient of the brake pad to be evaluated was increased 10% or more with respect to the lowest friction coefficient of the brake pad of Comparative Example 1 was evaluated as “improved”, the case where the lowest friction coefficient of the brake pad to be evaluated was decreased 10% or more with respect to the lowest friction coefficient of the brake pad of Comparative Example 1 was evaluated as “deteriorated”. The case where increase/decrease of the lowest friction coefficient of the brake pad to be evaluated with respect to the lowest friction coefficient of the brake pad of Comparative Example 1 was less than 10% was evaluated as “the same as or comparable to Comparative Example 1”.

### (Wear Amount)

The wear amount of the brake pad after the AMS fade test was measured according to the following method.

### (Method of Measuring Wear Amount)

The wear amount was measured according to JASO C427 6. Measurement Method.

After the test, with respect to 8 points per one brake pad, the wear amount of the pad was measured, and the averaged value was designated as “pad wear amount”. That is, “pad wear amount” described in Tables 1 and 2 has the same meaning as “pad average wear amount” described later.

The results of measuring the wear amount were evaluated in terms of 5 steps of scores 1 to 5 according to the following criteria.
5: improved more than 20% as compared with Comparative Example 1
4: improved 10% or more and 20% or less as compared with Comparative Example 1
3: the same as or comparable to Comparative Example 1
2: deteriorated 10% or more and 20% or less as compared with Comparative Example 1
1: deteriorated more than 20% as compared with Comparative Example 1

Here, the case where the wear amount of the brake pad to be evaluated was decreased 10% or more with respect to the wear amount of the brake pad of Comparative Example 1 was evaluated as “improved”, the case where the wear amount of the brake pad to be evaluated was increased 10% or more with respect to the wear amount of the brake pad of Comparative Example 1 was evaluated as “deteriorated”. The case where increase/decrease of the wear amount of the brake pad to be evaluated with respect to the wear amount of the brake pad of Comparative Example 1 was less than 10% was evaluated as “the same as or comparable to Comparative Example 1”.

### (Presence or Absence of Crack)

The external appearance of the brake pad after the AMS fade test was observed visually, and the presence/absence of crack on the brake pad was determined.

### <Driving Simulation Wear Test>

A test (common name: LACT simulation test) was performed by a bench testing machine which simulates street driving in Los Angeles (L.A.).

The estimated lifetime of the brake pad (pad estimated lifetime) (mile) was calculated from the following formula.

$$Pad Estimated lifetime ( mile ) = pad thickness ( mm ) / pad average wear amount ( mm ) \times driving distance of the test ( mile ) \qquad ( 1 )$$

Here, “pad thickness (mm)” is a thickness of the brake pad before the LACT simulation test, and “pad average wear amount (mm)” is the average wear amount of the brake pad before the LACT simulation test, and the measuring methods are described in JASO C427 6. Measurement Method.

The calculated results of the pad estimated lifetime were evaluated in terms of 5 steps of scores 1 to 5 according to the following criteria.
5: improved more than 20% as compared with Comparative Example 1
4: improved 10% or more and 20% or less as compared with Comparative Example 1
3: the same as or comparable to Comparative Example 1
2: deteriorated 10% or more and 20% or less as compared with Comparative Example 1
1: deteriorated more than 20% as compared with Comparative Example 1

Here, the case where the pad estimated lifetime of the brake pad to be evaluated was increased 10% or more with respect to the pad estimated lifetime of the brake pad of Comparative Example 1 was evaluated as “improved”, the case where the pad estimated lifetime of the brake pad to be evaluated was decreased 10% or more with respect to the pad estimated lifetime of the brake pad of Comparative Example 1 was evaluated as “deteriorated”. The case where increase/decrease of the pad estimated lifetime of the brake pad to be evaluated with respect to the pad estimated lifetime of the brake pad of Comparative Example 1 was less than 10% was evaluated as “the same as or comparable to Comparative Example 1”.

### Results

The respective evaluation results of the high-speed test and the evaluation result of the driving simulation wear test are shown in Tables 1 and 2.

TABLE 1

| | | | Ex- | Ex- | Ex- | Ex- | Ex- | Ex- | Ex- | Ex- | Ex- | Ex- | Ex- | Ex- | Ex- |
|---|---|---|---|---|---|---|---|---|---|---|---|---|---|---|---|
| | | | am- | am- | am- | am- | am- | am- | am- | am- | am- | am- | am- | am- | am- |
| | | | ple 1 | ple 2 | ple 3 | ple 4 | ple 5 | ple 6 | ple 7 | ple 8 | ple 9 | ple 10 | ple 11 | ple 12 | ple 13 |
| Metal | SUS Fiber | | | | | | | | | | | | 1 | 5 | |
| fiber | Copper Fiber | | | | | | | | | | | | | | 1 |
| Binder | Phenol Resin | | 9 | 9 | 9 | 9 | 9 | 9 | 9 | 9 | 9 | 9 | 9 | 9 | 9 |
| Fiber | Aramid Fiber | | 4 | 4 | 4 | 4 | 4 | 4 | 4 | 4 | 4 | 4 | 4 | 4 | 4 |
| Substrate | Inorganic Fiber | | 5 | 5 | 5 | 5 | 5 | 5 | 5 | 5 | 5 | 5 | 5 | 5 | 5 |
| Titanate | | | 16 | 16 | 16 | 16 | 16 | 16 | 16 | 16 | 16 | 16 | 16 | 16 | 16 |
| Lubricant | Black Lead | | 4 | 4 | 4 | 4 | 4 | 4 | 4 | 4 | 4 | 4 | 4 | 4 | 4 |
| | Sulfide | | 3 | 3 | 3 | 3 | 3 | 3 | 3 | 3 | 3 | 3 | 3 | 3 | 3 |
| Inorganic | Zirconium | | 20 | 20 | 20 | 20 | 20 | 20 | 20 | 20 | 20 | 20 | 20 | 20 | 20 |
| Filler | Oxide | | | | | | | | | | | | | | |
| | Barium | | 25 | 23 | 20 | 16 | 11 | 25 | 23 | 23 | 23 | 16 | 22 | 20 | 22 |
| | Sulfate | | | | | | | | | | | | | | |
| | Mica | | 4 | 4 | 4 | 4 | 4 | 4 | 4 | 4 | 4 | 4 | 4 | 4 | 4 |
| | Iron | | 4 | 4 | 4 | 4 | 4 | 4 | 4 | 4 | 4 | 4 | 4 | 4 | 4 |
| | Oxide | | | | | | | | | | | | | | |
| Organic Filler | | | 3 | 3 | 3 | 3 | 3 | 3 | 3 | 3 | 3 | 3 | 3 | 3 | 3 |
| Calcium Hydroxide | | | 2 | 2 | 2 | 2 | 2 | 2 | 2 | 2 | 2 | 2 | 2 | 2 | 2 |
| Magnesite | Particle Size: 1 μm | | | | | | | 1 | 3 | | | | | | |
| | Particle Size: 8 μm | | 1 | 3 | 6 | 10 | 15 | | | | | | 3 | 1 | |
| | Particle Size: 20 μm | | | | | | | | | 3 | | | | | 3 |
| | Particle Size: 50 μm | | | | | | | | | | 3 | 10 | | | |
| Basic | Particle Size: 10 μm | | | | | | | | | | | | | | |
| Magnesium | | | | | | | | | | | | | | | |
| Carbonate | | | | | | | | | | | | | | | |
| Dolomite | Particle Size: 8 μm | | | | | | | | | | | | | | |
| Magnesium | Particle Size: 2 μm | | | | | | | | | | | | | | |
| Oxide | | | | | | | | | | | | | | | |
| Total (% by mass) | | | 100 | 100 | 100 | 100 | 100 | 100 | 100 | 100 | 100 | 100 | 100 | 100 | 100 |
| Evaluation | High | Lowest | 4 | 4 | 5 | 5 | 5 | 4 | 5 | 5 | 5 | 5 | 5 | 5 | 5 |
| Results | Temper- | Friction | | | | | | | | | | | | | |
| | ature | Coefficient | | | | | | | | | | | | | |
| | Test | Pad Wear | 4 | 5 | 5 | 5 | 5 | 4 | 5 | 5 | 5 | 5 | 5 | 5 | 5 |
| | | Amount | | | | | | | | | | | | | |
| | | Pad Crack | ab- | ab- | ab- | ab- | ab- | ab- | ab- | ab- | ab- | ab- | ab- | ab- | ab- |
| | | | sence | sence | sence | sence | sence | sence | sence | sence | sence | sence | sence | sence | sence |
| | Driving | Pad | 4 | 4 | 4 | 3 | 2 | 4 | 4 | 4 | 3 | 3 | 3 | 3 | 3 |
| | Simulation | Estimated | | | | | | | | | | | | | |
| | Wear | Lifetime | | | | | | | | | | | | | |
| | Test | | | | | | | | | | | | | | |

TABLE 2

| | | | Com- | Com- | Com- | Com- | Com- | Com- | Com- | Com- | Com- | Com- | Com- | Com- |
|---|---|---|---|---|---|---|---|---|---|---|---|---|---|---|
| | | | par- | par- | par- | par- | par- | par- | par- | par- | par- | par- | par- | par- |
| | | | ative | ative | ative | ative | ative | ative | ative | ative | ative | ative | ative | ative |
| | | | Ex- | Ex- | Ex- | Ex- | Ex- | Ex- | Ex- | Ex- | Ex- | Ex- | Ex- | Ex- |
| | | | am- | am- | am- | am- | am- | am- | am- | am- | am- | am- | am- | am- |
| | | | ple 1 | ple 2 | ple 3 | ple 4 | ple 5 | ple 6 | ple 7 | ple 8 | ple 9 | ple 10 | ple 11 | ple 12 |
| Metal | SUS Fiber | | | | | | | | | | | | 10 | 10 |
| fiber | Copper Fiber | | | | | | | | | | | 10 | | |
| Binder | Phenol Resin | | 9 | 9 | 9 | 9 | 9 | 9 | 9 | 9 | 9 | 9 | 9 | 9 |
| Fiber | Aramid Fiber | | 4 | 4 | 4 | 4 | 4 | 4 | 4 | 4 | 4 | 4 | 4 | 4 |
| Substrate | Inorganic Fiber | | 5 | 5 | 5 | 5 | 5 | 5 | 5 | 5 | 5 | 5 | 5 | 5 |
| Titanate | | | 16 | 16 | 16 | 16 | 16 | 16 | 16 | 16 | 16 | 16 | 16 | 16 |
| Lubricant | Black Lead | | 4 | 4 | 4 | 4 | 4 | 4 | 4 | 4 | 4 | 4 | 4 | 4 |
| | Sulfide | | 3 | 3 | 3 | 3 | 3 | 3 | 3 | 3 | 3 | 3 | 3 | 3 |
| Inorganic | Zirconium Oxide | | 20 | 20 | 20 | 20 | 20 | 20 | 20 | 20 | 20 | 20 | 20 | 20 |
| Filler | Barium Sulfate | | 26 | 25 | 23 | 20 | 25 | 23 | 20 | 25 | 23 | 13 | 16 | 13 |
| | Mica | | 4 | 4 | 4 | 4 | 4 | 4 | 4 | 4 | 4 | 4 | 4 | 4 |
| | Iron Oxide | | 4 | 4 | 4 | 4 | 4 | 4 | 4 | 4 | 4 | 4 | 4 | 4 |
| Organic Filler | | | 3 | 3 | 3 | 3 | 3 | 3 | 3 | 3 | 3 | 3 | 3 | 3 |
| Calcium Hydroxide | | | 2 | 2 | 2 | 2 | 2 | 2 | 2 | 2 | 2 | 2 | 2 | 2 |
| Magnesite | Particle Size: 1 μm | | | | | | | | | | | | | |
| | Particle Size: 8 μm | | | | | | | | | | | 3 | | 3 |
| | Particle Size: 20 μm | | | | | | | | | | | | | |
| | Particle Size: 50 μm | | | | | | | | | | | | | |
| Basic | Particle Size: 10 μm | | | 1 | 3 | 6 | | | | | | | | |
| Magnesium | | | | | | | | | | | | | | |
| Carbonate | | | | | | | | | | | | | | |
| Dolomite | Particle Size: 8 μm | | | | | | 1 | 3 | 6 | | | | | |
| Magnesium | Particle Size: 2 μm | | | | | | | | | 1 | 3 | | | |
| Oxide | | | | | | | | | | | | | | |
| Total (% by mass) | | | 100 | 100 | 100 | 100 | 100 | 100 | 100 | 100 | 100 | 100 | 100 | 100 |
| Evaluation | High | Lowest | — | 3 | 4 | 4 | 3 | 3 | 4 | 4 | 5 | 5 | 4 | 5 |
| Results | Temperature | Friction | | | | | | | | | | | | |
| | Test | Coefficient | | | | | | | | | | | | |
| | | Pad Wear | — | 4 | 4 | 4 | 3 | 4 | 4 | 4 | 5 | 5 | 4 | 5 |
| | | Amount | | | | | | | | | | | | |
| | | Pad Crack | pre- | pre- | pre- | pre- | pre- | pre- | pre- | ab- | ab- | ab- | ab- | ab- |
| | | | sence | sence | sence | sence | sence | sence | sence | sence | sence | sence | sence | sence |
| | Driving | Pad | — | 3 | 1 | 1 | 3 | 3 | 1 | 1 | 1 | 1 | 1 | 1 |
| | Simulation | Estimated | | | | | | | | | | | | |
| | Wear Test | Lifetime | | | | | | | | | | | | |

As shown in Table 1, it has been confirmed that since the brake pads of Examples 1 to 13 contain magnesite as the inorganic filler, they are excellent in the effect and the wear resistance at the time of high-speed braking in the high temperature range as compared with the brake pad of Comparative Example 1 and further have a sufficient wear resistance in the ordinary temperature range.

On the other hand, with respect to the brake pads of Comparative Examples containing the basic magnesium carbonate (Comparative Examples 2 to 4), dolomite (Comparative Examples 5 to 6), or magnesium oxide (Comparative Examples 8 to 9) as the inorganic filler, it was not possible to achieve both enhancement in performance at the time of high-speed braking in the high temperature range and the wear resistance in the ordinary temperature range simultaneously.

It appeared that the brake pads of Comparative Examples 2 to 4 containing the basic magnesium carbonate exhibited lowered wear resistance at the ordinary temperature range, since the basic magnesium carbonate is liable to reach the temperature at which the hydrate desorbs particularly at street driving.

Further, dolomite is a carbonate of magnesium and calcium, and therefore, decomposes upon friction at the time of high-speed braking in the high temperature range to thereby form calcium oxide. Calcium oxide is strong alkaline, so the alkaline component in the friction material composition becomes excessive, and with respect to the brake pads of Comparative Examples 5 to 7 containing dolomite, it appears that the resin in the friction material is decomposed to thereby lower the strength of the friction material present in the vicinity of the friction surface, so the friction coefficient (u) in the high temperature range of 600° C. or more is unlikely to increase, and the above appears to be the reason why crack was generated in the friction material.

Further, the Mohs hardness of magnesite is approximately from 3.5 to 4.5, while the Mohs hardness of magnesium oxide is as high as around 6. This appeared to cause the brake pads of Comparative Examples 8 to 9 containing magnesium oxide to have lowered wear resistance at the ordinary temperature range.

From the above results, it can be seen that the adoption of magnesite as the inorganic filler containing magnesium component enables both enhancement in performance at the time of high-speed braking in the high temperature range and wear resistance in the ordinary temperature range to be satisfactory simultaneously.

Further, comparing Example 2 with Comparative Example 10, it is indicated that, with respect to the composition containing magnesite, with the content of the copper component in the friction material composition being increased, performance at the time of high-speed braking in the high temperature range is enhanced, and, on the other hand, the wear resistance at the ordinary temperature range is lowered. Accordingly, with respect to the case of incorporating a copper fiber as the metal fiber into the friction material composition, it has been apparent that the content of copper in the friction material composition is preferably 5% by mass or less in terms of elemental copper, and the content of copper in the friction material composition is more preferably 0% by mass in terms of elemental copper (free of copper).

Incidentally, comparing Examples 11 and 12 with Comparative Examples 11 and 12, with respect to the case of incorporating a chromium-containing fiber, such as the SUS fiber, as the metal fiber into the friction material composition, when the content of the chromium-containing fiber in the friction material composition is in the range of 1% by mass or more and 5% by mass or less, it can be seen that both enhancement in performance at the time of high-speed braking in the high temperature range and wear resistance in the ordinary temperature range can be made comparably good simultaneously.

### INDUSTRIAL APPLICABILITY

The friction material composition and the friction material according to an embodiment of the present disclosure can be utilized suitably for a friction member mounted in the braking device of a vehicle such as a car.

1. A friction material composition comprising a fiber substrate, a binder, an organic filler and an inorganic filler,
wherein the content of copper in the friction material composition is 5% by mass or less in terms of elemental copper, and the friction material composition comprises magnesite as the inorganic filler.

2. The friction material composition according to claim 1, wherein the content of magnesite in the friction material composition is 1% by mass or more and 10% by mass or less.

3. The friction material composition according to claim 2, wherein the average particle size of magnesite is 50 μm or less.

4. The friction material composition according to claim 3, wherein the content of copper in the friction material composition is 0.5% by mass or less in terms of elemental copper.

5. The friction material composition according to claim 4, wherein the friction material composition comprises a chromium-containing metal fiber as the fiber substrate, and the content of the chromium-containing metal fiber in the friction material composition is 1% by mass or more and 5% by mass or less.

6. A friction material, which is obtained by molding the friction material composition according to claim 5.

7. The friction material composition according to claim 3, wherein the friction material composition comprises a chromium-containing metal fiber as the fiber substrate, and the content of the chromium-containing metal fiber in the friction material composition is 1% by mass or more and 5% by mass or less.

8. A friction material, which is obtained by molding the friction material composition according to claim 3.

9. The friction material composition according to claim 2, wherein the content of copper in the friction material composition is 0.5% by mass or less in terms of elemental copper.

10. The friction material composition according to claim 9, wherein the friction material composition comprises a chromium-containing metal fiber as the fiber substrate, and the content of the chromium-containing metal fiber in the friction material composition is 1% by mass or more and 5% by mass or less.

11. The friction material composition according to claim 2, wherein the friction material composition comprises a chromium-containing metal fiber as the fiber substrate, and the content of the chromium-containing metal fiber in the friction material composition is 1% by mass or more and 5% by mass or less.

12. A friction material, which is obtained by molding the friction material composition according to claim 2.

13. The friction material composition according to claim 1, wherein the average particle size of magnesite is 50 μm or less.

14. The friction material composition according to claim 13, wherein the content of copper in the friction material composition is 0.5% by mass or less in terms of elemental copper.

15. The friction material composition according to claim 14, wherein the friction material composition comprises a chromium-containing metal fiber as the fiber substrate, and the content of the chromium-containing metal fiber in the friction material composition is 1% by mass or more and 5% by mass or less.

16. The friction material composition according to claim 13, wherein the friction material composition comprises a chromium-containing metal fiber as the fiber substrate, and the content of the chromium-containing metal fiber in the friction material composition is 1% by mass or more and 5% by mass or less.

17. The friction material composition according to claim 1, wherein the content of copper in the friction material composition is 0.5% by mass or less in terms of elemental copper.

18. The friction material composition according to claim 17, wherein the friction material composition comprises a chromium-containing metal fiber as the fiber substrate, and the content of the chromium-containing metal fiber in the friction material composition is 1% by mass or more and 5% by mass or less.

19. The friction material composition according to claim 1, wherein the friction material composition comprises a chromium-containing metal fiber as the fiber substrate, and the content of the chromium-containing metal fiber in the friction material composition is 1% by mass or more and 5% by mass or less.

20. A friction material, which is obtained by molding the friction material composition according to claim 1.
